(19) United States
(12) Patent Application Publication
(10) Pub. No.: US 2018/0281475 A1
(43) Pub. Date: Oct. 4, 2018

(54) DETECTING LABEL STOPS

(71) Applicant: Datamax-O'Neil Corporation, Orlando, FL (US)

(72) Inventor: Erik Unemyr, Singapore (SG)

(21) Appl. No.: 15/473,944

(22) Filed: Mar. 30, 2017

(51) Int. Cl. B41J 13/00; B41J 3/407

(52) U.S. Cl. CPC B41J 13/0009; B41J 3/4075

(57) ABSTRACT

For detecting label stops in a label printer, a label stop sensing device is provided. In one implementation, the label stop sensing device comprises a sensor configured to sense print media being fed through a printer, wherein the print media comprises a plurality of labels separated by gaps. Also, the label stop sensing device includes a gap detecting module having a Fast Fourier Transform (FFT) module. The FFT module is configured to receive time domain signals of the sensed print media from the sensor and to obtain frequency domain signals. The gap detecting module is configured to detect the gaps between the labels on the print media based on at least the frequency domain signals.

### FIELD OF THE INVENTION

The present invention relates to label printers and more particularly relates to detecting gaps between labels on continuous stock.

### BACKGROUND

Generally speaking, label printers are used in a number of different environments for printing various types of labels. In a logistics environment, for example, shipping labels may be printed onto self-adhesive labels and then placed on packages for tracking purposes. Pharmacies may print medical/patient information on labels that are applied to medicine containers. These and other types of label printers are used by many different types of businesses for various printing needs.

It should be understood from the above examples that each label printer may be configured for printing on a specific size and shape of labels. There are some label printers, however, that may even be configured to print onto different sizes and types of labels when they are properly adjusted for the appropriate labels.

Before being printed, self-adhesive labels are usually attached to a continuous band of media stock that is fed through the printer. There may be differences in the media stock depending on the suppliers. For example, the sizes of the labels may be slightly different or the gaps between the labels may also differ slightly. Therefore, many label printers include sensors for detecting where each label is positioned on the continuous stock to control how to feed the media for printing.

Although many label stop sensors (LSSs) are able to detect a gap in between two adjacent labels on the media, at times the LSSs may fail to detect some gaps. In other situations, the LSSs may incorrectly interpret certain characteristics of a label (e.g., labels having pre-printed text or images thereon) as a gap. Therefore, a need exists for providing LSSs that can accurately detect gaps or label stops on continuous media being fed through label printers. By properly detecting every gap and by preventing the detection of false gaps, material waste can be minimized.

### SUMMARY

Accordingly, in one aspect, the present invention embraces label printers and label printing devices. The present invention also embraces label stop sensors (LSSs) and label stop sensing devices. Also, the present invention embraces other systems and methods for printing onto labels and detecting gaps between labels.

In an exemplary embodiment, a label printing device is disclosed, the label printing device comprising a media feeding mechanism configured to feed print media through a print area to an exit of the label printer. The print media has a plurality of labels separated by a plurality of gaps. The label printing device further comprises a printing mechanism configured to print on the labels of the print media. Furthermore, the label printing device includes a label stop sensing device configured to sense the gaps between the labels on the print media. The label stop sensing device is further configured to control the media feeding mechanism and printing mechanism to prevent the printing mechanism from printing outside the boundaries of the labels. The label stop sensing device performs a Fast Fourier Transform (FFT) to help predict the locations of the gaps.

In another exemplary embodiment, a label stop sensing device includes a sensor configured to sense print media being fed through a printer. The print media comprises a plurality of labels separated by gaps. The label stop sensing device further includes a gap detecting module configured to receive time domain signals from the sensor. The gap detecting module is configured to perform a Fast Fourier Transform (FFT) on the time domain signals to obtain frequency domain signals. Also, the gap detecting module is configured to detect the gaps between the labels on the print media based on at least the frequency domain signals.

In yet another exemplary embodiment, a method associated with a printer is provided. The method comprises a step of sensing print media being fed through a printer, wherein the print media includes a plurality of labels separated by gaps. The method also includes the steps of performing a Fast Fourier Transform (FFT) on the sensed print media and detecting the gaps between the labels on the print media based on at least frequency domain signals.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 schematically depicts a perspective view of a label printer according to an embodiment of the present invention.

FIGS. 2A-2F schematically depict various types of labels for which gaps are to be detected, according to various embodiments of the present invention.

FIGS. 3A-3C schematically depict a front view, a side view, and a top view, respectively, of a sensor for sensing continuous media, according to embodiments of the present invention.

FIG. 4 schematically depicts a block diagram of a label printing device according to an embodiment of the present invention.

FIG. 5 schematically depicts a block diagram of the label stop sensing device shown in FIG. 4, according to an embodiment of the present invention.

FIG. 6 schematically depicts a first graph showing sensor signals, according to an exemplary implementation of the present invention.

FIG. 7 schematically depicts a second graph showing sensor signals, according to an exemplary implementation of the present invention.

FIG. 8 schematically depicts third and fourth graphs showing magnitude and phase signals, according to exemplary implementations of the present invention.

### DETAILED DESCRIPTION

The present invention embraces printers and more particularly embraces printers designed for printing onto labels. In particular, the present invention also includes label stop sensors (LSSs) and other sensing devices for detecting the gaps in between unprinted labels on a continuous band of media stock. Many conventional LSSs fail to detect every gap or sometimes sense a characteristic of the label that is incorrectly interpreted as a gap. Thus, the present invention is intended to detect these gaps more accurately than conventional LSSs to thereby minimize non-detection of gaps and to minimize false detection when various characteristics of the labels are incorrectly interpreted as gaps.

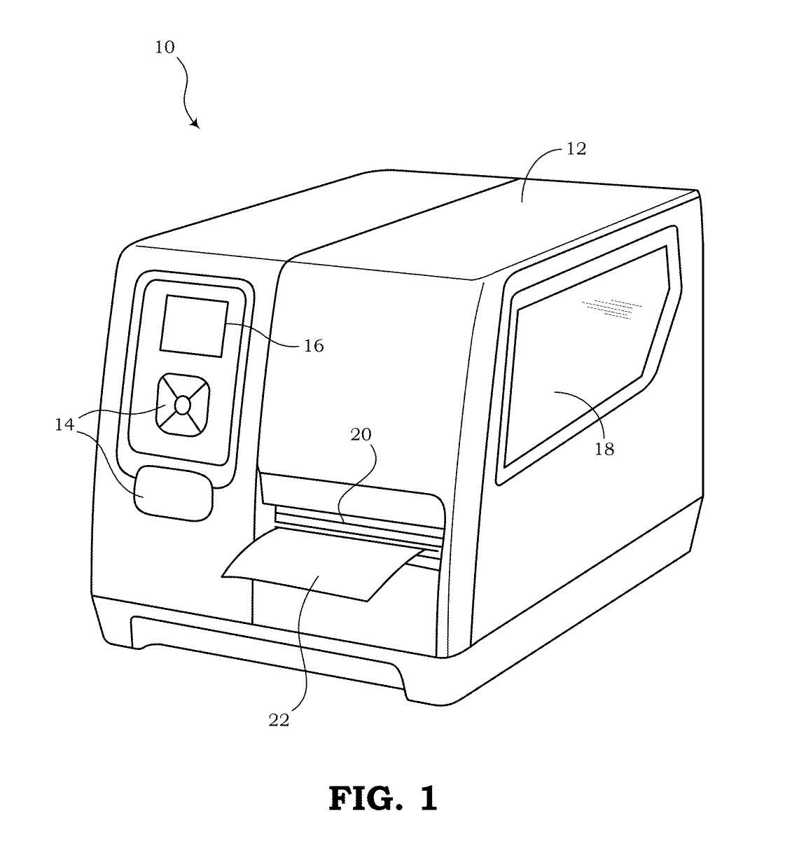

FIG. 1 is a perspective view illustrating an embodiment of a label printer 10. As shown in FIG. 1, the label printer 10 includes a housing 12, which is configured to protect internal components of the label printer 10. For example, the housing 12 may be configured to protect, among other things, media on which labels are printed, a printing mechanism that prints on the media, media feeding mechanisms that feed the media through the label printer 10, the thermal printhead, and other components as are known to one of ordinary skill in the art.

The label printer 10 further includes, among other things, user input elements 14, user output elements 16, a window 18, and an exit port 20 from which one or more printed labels 22 are expelled. The user input elements 14, for example, may include buttons, switches, knobs, and/or other input devices for receiving input or commands from a user. The user output elements 16, for example, may include lights, LEDs, display screens, audible output elements, etc., for providing various outputs to the user. The window 18, which may be optional in some printers, can be placed in the side of the housing 12 to allow a user to see inside the label printer 10, such as to determine the remaining stock.

The exit port 20 may include rollers and/or other portions of the media feeding mechanisms as described herein. In some embodiments, the exit port 20 may include straight edges for media tearing or other components to assist the user with removing printed labels from the continuous stock remaining inside the housing 12.

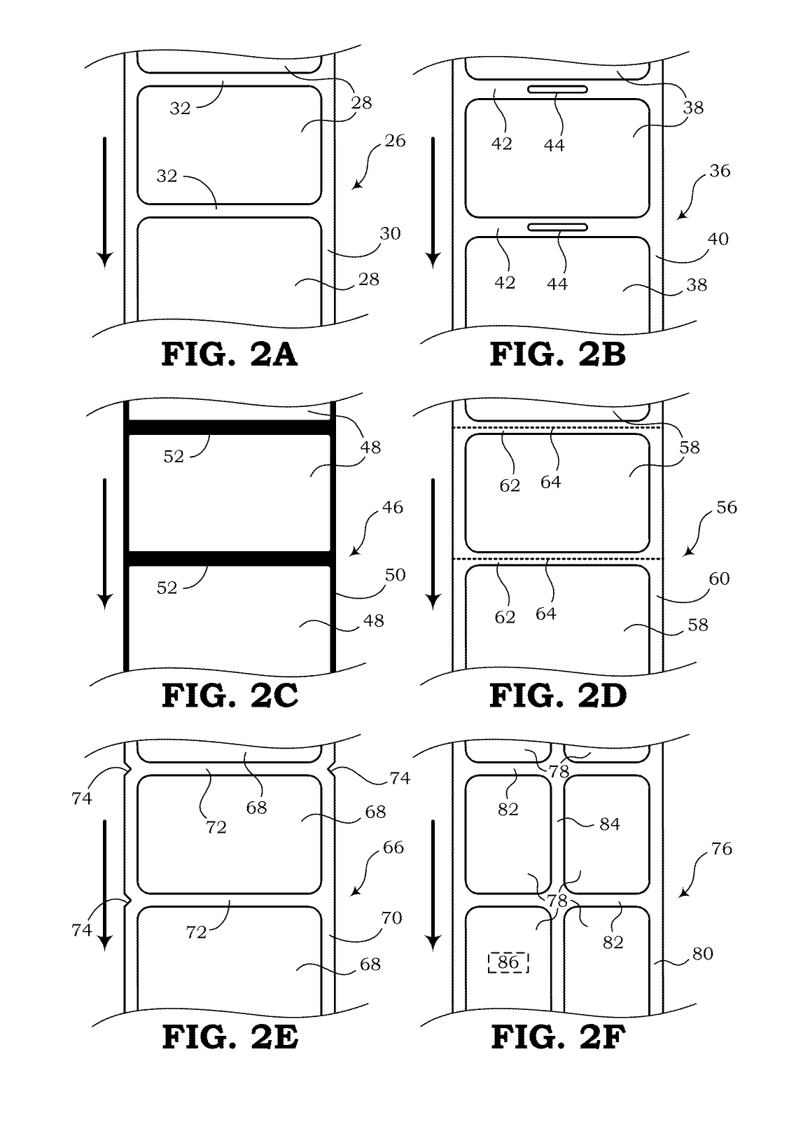

FIGS. 2A-2F illustrate various exemplary embodiments of media stock on which unprinted labels are attached. The gaps between the adjacent labels are intended to be accurately detected by the sensing devices describes in the present disclosure. FIG. 2A shows a first type of media stock 26, which includes a continuous arrangement of labels 28 attached to a backing material 30. The labels 28 are separated from each other on the backing material 30 by gaps 32.

FIG. 2B shows a second type of media stock 36, which includes a continuous arrangement of labels 38 attached to a backing material 40. The labels 38 are separated from each other by gaps 42. Also, the media stock 36 further include slots 44 formed in the gaps 42. The slots 44 may allow line-of-sight detection of the gaps 42 by sensors on the top and bottom of the media stock 36 as it is passed through the printer.

FIG. 2C shows a third type of media stock 46, which includes a continuous arrangement of labels 48 attached to a backing material 50. The labels 48 are separated from each other by gaps 52. In this embodiment, the backing material 50 may include a color or shade that greatly contrasts the color or shade of the labels 48 to thereby allow easy distinction between the boundaries of the labels 48 and the portions of the backing material 50 or gaps 52. In particular, the gaps 52 of this type of media stock 46 are typically referred to as black marks.

FIG. 2D shows a fourth type of media stock 56, which includes a continuous arrangement of labels 58 attached to a backing material 60. The labels 58 are separated from each other by gaps 62. Also, the gaps 62 further include perforations 64, which may be used to assist the user when separating printed labels from each other and/or from the unprinted media.

FIG. 2E shows a fifth type of media stock 66, which includes a continuous arrangement of labels 68 attached to a backing material 70. The labels 68 are separated from each other by gaps 72. The media stock 66 may be configured such notches 74 are formed on the edges of the backing material 70, preferably at the position of the gaps 72. In some examples, notches 74 may be formed on both sides of the backing material 70 or on just one side.

FIG. 2F shows a sixth type of media stock 76, which includes an arrangement of labels 78 in rows and columns. The labels 78 are attached to a backing material 80. Each row may include any number of labels 78. Rows of labels 78 are therefore separated from other rows by gaps 82 and the labels 78 in each row are separated from each other by center gaps 84. For this type of media stock 76, sensors for detecting gaps need to distinguish row gaps 82 from column gaps 84. Therefore, the sensors can be adjusted off center to a position, such as position 86 in the middle of one column of labels 78 so that only the row gaps 82 are detected when the media stock 76 is fed in the direction of the arrow.

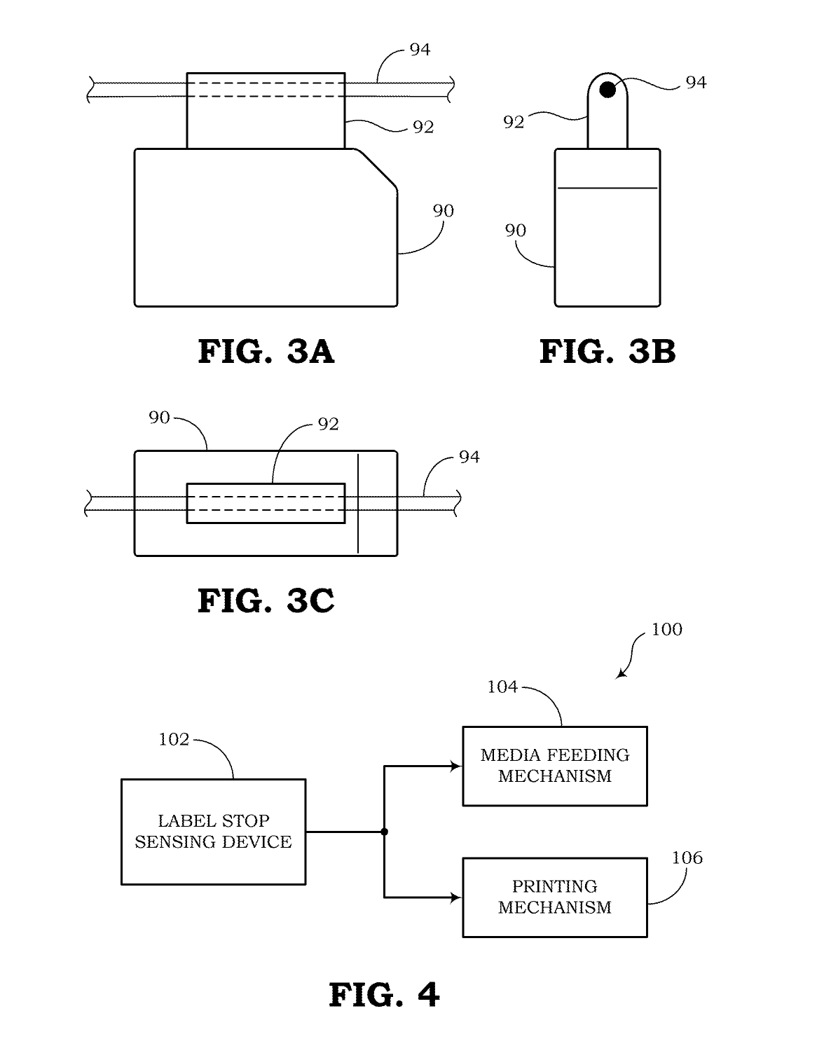

FIGS. 3A-3C illustrate a front view, a side view, and a top view, respectively, of a sensor 90 for sensing characteristics of the continuous media. The sensor 90 may be a photoelectric sensor or other suitable type of sensing device for sensing changes in various. In some embodiments, the sensor 90 may function by itself. However, according to other embodiments, the sensor 90 may be combined with another sensor, where one sensor (e.g., sensor 90) is positioned above the media stock and the other sensor is positioned below the media stock.

The sensor 90 as shown in FIG. 3 may be positioned above the media stock and may include sensing elements on a bottom portion thereof. When a second sensor is used, the sensor may be positioned below the media stock and include sensing elements on a top portion thereof. The sensor 90 may include an extension 92 that connects between the body of the sensor 90 and an adjustment arm 94. The adjustment arm 94 may be a component that is supported in the housing 12 in a stationary manner. By making positioning adjustments, such as by turning a screw element of the adjustment arm 94, the sensor 90 can be moved laterally along the adjustment arm 94, which may be shown as a side-to-side movement with respect to FIG. 3A or FIG. 3C.

Therefore, to properly position the sensor 90 with respect to media stock shown in FIGS. 2A-2E, the sensor 90 may be moved along the adjustment arm 94 to a center position with respect to the width of the backing material 30, 40, 50, 60, 70. However, for use with media stock having columns of labels (e.g., as shown in FIG. 2F), the sensor 90 may be adjusted along the adjustment arm 94 to a position aligned with one column of the labels, such as position 86 shown in FIG. 2F.

FIG. 4 is a block diagram illustrating an embodiment of a label printing device 100. The label printing device 100 is preferably supported inside the housing 12 of the label printer 10. The label printing device 100, according to the embodiment of FIG. 4, includes a label stop sensing device 102, a media feeding mechanism 104, and a printing mechanism 106. The label stop sensing device 102 senses the label stops (or gaps, black marks, slots, perforations, holes, voids, or notches) between labels arranged on the media stock. In response to determining the positions of these stops or gaps, the media feeding mechanism 104 is configured to feed the media along a path such that the printing mechanism 106 can print only within the boundaries of the labels. The media feeding mechanism 104 also moves the printed labels out through the exit port 20 shown in FIG. 1.

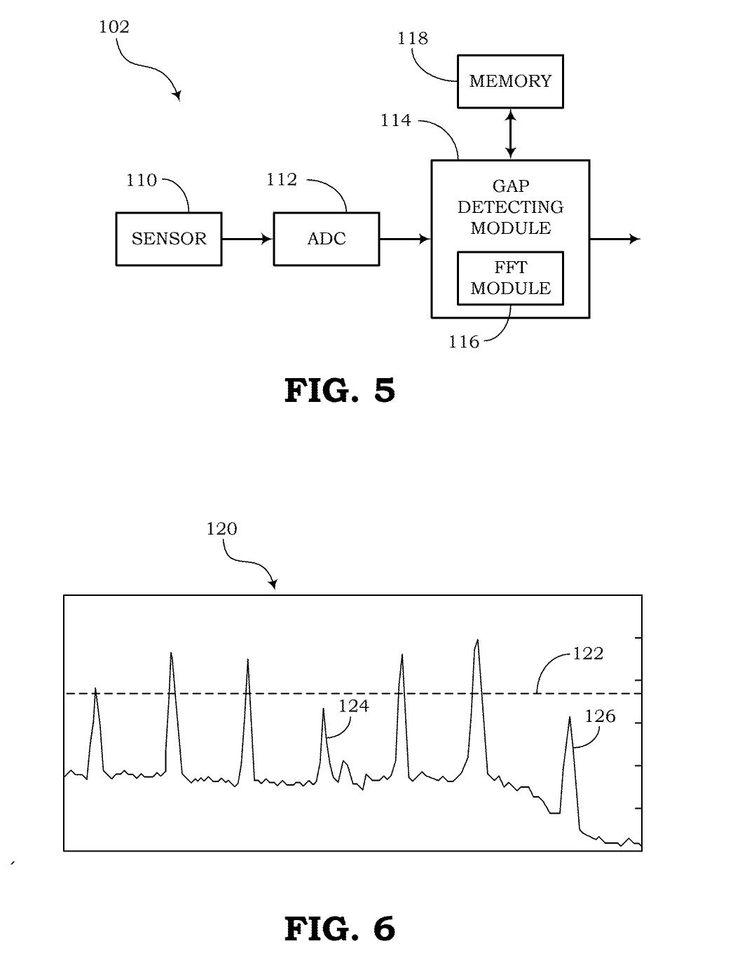

Therefore, according to some implementations, the label printing device 100 may include the media feeding mechanism 104, which may be configured to feed print media (e.g., media 26, 36, 46, 56, 66, or 76) through a print area in the interior of the label printer 10 to an exit (e.g., exit port 20) of the label printer 10. The print media may include a plurality of labels 28, 38, 48, 58, 68, 78 separated by a plurality of gaps (e.g., horizontal gaps 32, 42, 52, 62, 72, 82). The label printing device 100 also comprises the printing mechanism 106 configured to print on the labels of the print media. The label stop sensing device 102 is configured to sense the gaps between the labels on the print media. The label stop sensing device 102 is further configured to control the media feeding mechanism 104 and printing mechanism 106 to prevent the printing mechanism 106 from printing outside the boundaries of the labels. Furthermore, the label stop sensing device 102 may perform a Fast Fourier Transform (FFT) (as described below with respect to FIG. 5) to help predict the locations of the gaps. By performing FFT, the label stop sensing device 102 may be configured to filter out false gap detection for pre-printed media.

The gaps 32, 42, 52, 62, 72, 82 in the media stock may include label stops, black marks, slots, perforations, holes, voids, and/or notches. The label stop sensing device 100 may further include a memory device configured to store at least one table utilized by the label stop sensing device 102. The memory device may be configured to store a first table including signal magnitude values in the time domain and a second table including reoccurring frequencies with associated magnitudes and phase values in the frequency domain. The label stop sensing device 100 may be configured to detect if sensed signal values exceed a predetermined threshold value and if the sensed signal values correlate to information in the second table.

FIG. 5 is a block diagram illustrating an embodiment of the label stop sensing device 102 shown in FIG. 4. In this embodiment, the label stop sensing device 102 includes a sensor 110, an analog-to-digital converter (ADC) 112, a gap detecting module 114 having at least a FFT module 116, and memory 118. The gap detecting module 114 may be a label stop detecting module or other device for detecting gaps, label stops, black marks, slots, perforations, holes, voids, notches, or other separation/discontinuity features. The sensor 110 may be configured as the sensor 90 shown in FIG. 3 or other suitable sensing device for sensing characteristics of the media stock as it is being fed through the printer.

Outputs from the sensor 110 are provided to the ADC 112. The ADC 112 converts the analog signals from the sensor 110 to digital signals. The gap detecting module 114 may include processing elements and/or software stored in the label printer 10 for performing various operations to detect gaps between labels on print media. The gap detecting module 114 receives the digital signals from the ADC 112 and provides an output indicative of the locations of detected gaps. The FFT module 116 converts time domain signals to frequency domain signals. As described with respect to FIG. 4, the gap location information that is output from the gap detecting module 114 is used by the media feeding mechanism 104 and printing mechanism 106 to properly feed the media and print the labels within the boundaries of the labels.

According to some implementations, the label stop sensing device 102 may simply comprise the sensor 110 and the gap detecting module 114. The sensor 110 is configured to sense print media being fed through the label printer 10, wherein the print media comprises a plurality of labels separated by gaps. The FFT module 116 may be configured to convert time domain signals of the sensed print media from the sensor 110 to obtain frequency domain signals. The gap detecting module 114 is configured to utilize the frequency domain signals obtained by the FFT module 116 in order to detect the gaps, label stops, black marks, slots, perforations, holes, voids, or notches between the labels on the print media based on at least the frequency domain signals.

In some embodiments, the label stop sensing device 102 may include the analog to digital converter (ADC) 112 shown in FIG. 5, wherein the ADC 112 is configured to receive sensor signals in analog form and convert the signals to digital form. The label stop sensing device 102 may further include a memory device (e.g., memory 118 shown in FIG. 5) configured to store tables utilized by the gap detecting module 114. The memory device may be configured to store at least one time domain table that includes magnitude values in the time domain. The memory device may also be configured to store at least one frequency domain table that includes reoccurring frequencies with associated magnitude values and phase values in the frequency domain. The gap detecting module 114 may be configured to detect if signal magnitude values exceed a predetermined threshold value and if signal magnitude values correlate to information in the frequency domain table.

According to some embodiments, the gap detecting module 114 may be configured to use the frequency domain signals obtained by the FFT module 116 to predict the position of gaps in order to reduce missed gap detection. Also, the gap detecting module 114 may be configured to use the frequency domain signals from the FFT module 116 to filter out false gap detection when pre-printed media is fed through the label printer 10.

The label stop sensing device 102 may further include a processor (not shown) configured to receive the analog signals from the ADC 112. In this case, the processor may utilize the gap detecting module 114 and FFT module 116 as software for detecting the locations of gaps on the print media. In other embodiments, the gap detecting module 114 and FFT module 116 may be implemented as hardware in the processor or may include any combination of software, firmware, and/or hardware.

FIG. 6 illustrates a first graph 120 of exemplary sensor signals. The first graph 120 shows the magnitude of signal characteristics that might suggest the location of gaps between labels on the media stock. Again, gaps may also be configured as label stops, black marks, slots, perforations, holes, voids, notches, or other discontinuity or separation feature. The graph 120 may represent an output from the sensor 110 before the signal has been processed by the FFT module 116. In conventional systems, the signals of the graph 120 may simply be compared with a predetermined minimum threshold value 122, indicated in graph 120 by a dashed line. If the signal reaches or exceeds the predetermined minimum threshold value 122, then the conventional systems will interpret this as a gap. However, it should be noted that the sensed signals may not always have sufficient magnitude to reach the threshold value 122. For example, the peaks 124 and 126 fail to reach the threshold value 122 and thus the conventional systems would fail to interpret these characteristics as gaps.

However, by using the FFT module 116 in the process of detecting gaps according to the embodiments of the present invention, the FFT module 116 helps to predict the location of the gaps that occur at substantially regular intervals. The gap detecting module 114 not only relies on just the sensed signal shown in the graph 120 of FIG. 6, but also relies on the FFT prediction. Furthermore, the gap detecting module 114 may also rely on information stored in the memory 118.

The memory 118 may include tables of signal strength values in the time domain, which may correspond to the raw output from the sensor 110 shown, for example, in the graph 120 of FIG. 6. The memory 118 may also include tables of known reoccurring frequencies and the associated magnitudes and phases, which may correspond to frequency domain signals provided by the FFT module 116.

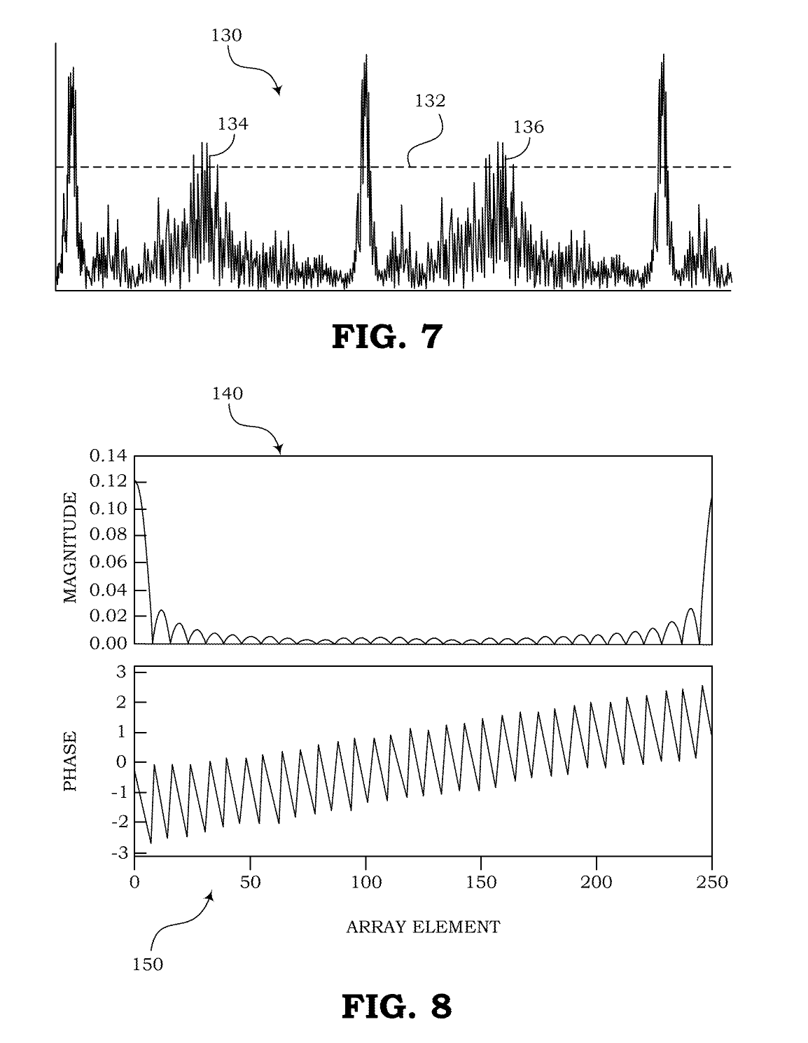

FIG. 7 illustrates a second graph 130 of exemplary sensor signals. This graph 130 may correspond to signals sensed from media stock that has pre-printed images and/or text on the labels. For instance, some labels, instead of being completely blank, may instead already contain certain types of pre-printed material, such as images and/or text, printed thereon. The pre-printed material may include watermarks, logos, letterhead information, barcodes, and/or other images or text that may be needed on all the labels to be printed.

With pre-printed image and/or text already on the labels, the sensors (e.g., sensor 90, 110) may detect a considerable amount of background noise, as shown in the graph 130 of FIG. 7. In this example, there may be repeating images, such as in the signal sections 134 and 136, which might appear to the sensors as gaps. If a sensor is used without the circuitry described with respect to FIGS. 4 and 5, the sensor may interpret the sections 134 and 136 as gaps since the section exceed a predetermined minimum threshold value 132, indicated by the dashed line. Notwithstanding, the gap detecting module 114 shown in FIG. 5 is configured to utilize the predictive information provided by the FFT module 116 and the tables from memory 118 to determine that the sections 134 and 136 are merely background noise and are not indicative of locations of gaps.

FIG. 8 illustrates third and fourth graphs 140, 150 of exemplary magnitude and phase signals. The information from these graphs 140, 150 may be stored in the memory 118 and used to assist the gap detecting module 114 in determining the presence and location of gaps as well as minimizing false detections.

The present invention may also be directed to methods associated with label printers. According to one exemplary method, a first step may include sensing print media 26, 36, 46, 56, 66, 76 being fed through a printer (e.g., label printer 10). As mentioned above, the print media may include a plurality of labels 28, 38, 48, 58, 68, 78 separated by gaps 32, 42, 52, 62, 72, 82. The method may further include performing a Fast Fourier Transform (FFT) on the sensed print media. Furthermore, the method may include the step of detecting the gaps 32, 42, 52, 62, 72, 82 between the labels 28, 38, 48, 58, 68, 78 on the print media 26, 36, 46, 56, 66, 76 based on at least frequency domain signals.

In some embodiments, the above method may further include the steps of controlling the media feeding mechanism 104 to feed the print media 26, 36, 46, 56, 66, 76 through a printing area of the label printer 10 to the exit port 20 of the label printer 10 and then controlling the printing mechanism 106 to print inside the boundaries of the labels 28, 38, 48, 58, 68, 78 of the print media 26, 36, 46, 56, 66, 76.

The method may also include the step of utilizing the FFT module 116 to help predict the locations of the gaps and to filter out false gap detection when pre-printed media is fed through the printer. Also, the method may include accessing a first table that includes magnitude values in the time domain and accessing a second table that includes reoccurring frequencies with associated magnitude values and phase values in the frequency domain. The step of detecting the gaps may include detecting if signal magnitude values exceed a predetermined threshold value and if the signal magnitude values correlate to information in the second table. The method may include another step of detecting the gaps by predicting the position of the gaps in order to reduce missed gap detection and filtering out false gap detection when pre-printed media is fed through the printer.

To supplement the present disclosure, this application incorporates entirely by reference the following commonly assigned patents, patent application publications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,525;
U.S. Pat. No. 8,794,526; U.S. Pat. No. 8,798,367;
U.S. Pat. No. 8,807,431; U.S. Pat. No. 8,807,432;
U.S. Pat. No. 8,820,630; U.S. Pat. No. 8,822,848;
U.S. Pat. No. 8,824,692; U.S. Pat. No. 8,824,696;
U.S. Pat. No. 8,842,849; U.S. Pat. No. 8,844,822;
U.S. Pat. No. 8,844,823; U.S. Pat. No. 8,849,019;
U.S. Pat. No. 8,851,383; U.S. Pat. No. 8,854,633;
U.S. Pat. No. 8,866,963; U.S. Pat. No. 8,868,421;
U.S. Pat. No. 8,868,519; U.S. Pat. No. 8,868,802;
U.S. Pat. No. 8,868,803; U.S. Pat. No. 8,870,074;
U.S. Pat. No. 8,879,639; U.S. Pat. No. 8,880,426;
U.S. Pat. No. 8,881,983; U.S. Pat. No. 8,881,987;
U.S. Pat. No. 8,903,172; U.S. Pat. No. 8,908,995;
U.S. Pat. No. 8,910,870; U.S. Pat. No. 8,910,875;
U.S. Pat. No. 8,914,290; U.S. Pat. No. 8,914,788;
U.S. Pat. No. 8,915,439; U.S. Pat. No. 8,915,444;
U.S. Pat. No. 8,916,789; U.S. Pat. No. 8,918,250;
U.S. Pat. No. 8,918,564; U.S. Pat. No. 8,925,818;
U.S. Pat. No. 8,939,374; U.S. Pat. No. 8,942,480;
U.S. Pat. No. 8,944,313; U.S. Pat. No. 8,944,327;
U.S. Pat. No. 8,944,332; U.S. Pat. No. 8,950,678;
U.S. Pat. No. 8,967,468; U.S. Pat. No. 8,971,346;
U.S. Pat. No. 8,976,030; U.S. Pat. No. 8,976,368;
U.S. Pat. No. 8,978,981; U.S. Pat. No. 8,978,983;
U.S. Pat. No. 8,978,984; U.S. Pat. No. 8,985,456;
U.S. Pat. No. 8,985,457; U.S. Pat. No. 8,985,459;
U.S. Pat. No. 8,985,461; U.S. Pat. No. 8,988,578;
U.S. Pat. No. 8,988,590; U.S. Pat. No. 8,991,704;
U.S. Pat. No. 8,996,194; U.S. Pat. No. 8,996,384;
U.S. Pat. No. 9,002,641; U.S. Pat. No. 9,007,368;
U.S. Pat. No. 9,010,641; U.S. Pat. No. 9,015,513;
U.S. Pat. No. 9,016,576; U.S. Pat. No. 9,022,288;
U.S. Pat. No. 9,030,964; U.S. Pat. No. 9,033,240;
U.S. Pat. No. 9,033,242; U.S. Pat. No. 9,036,054;
U.S. Pat. No. 9,037,344; U.S. Pat. No. 9,038,911;
U.S. Pat. No. 9,038,915; U.S. Pat. No. 9,047,098;
U.S. Pat. No. 9,047,359; U.S. Pat. No. 9,047,420;
U.S. Pat. No. 9,047,525; U.S. Pat. No. 9,047,531;
U.S. Pat. No. 9,053,055; U.S. Pat. No. 9,053,378;
U.S. Pat. No. 9,053,380; U.S. Pat. No. 9,058,526;
U.S. Pat. No. 9,064,165; U.S. Pat. No. 9,064,167;
U.S. Pat. No. 9,064,168; U.S. Pat. No. 9,064,254;
U.S. Pat. No. 9,066,032; U.S. Pat. No. 9,070,032;
U.S. Design Patent No. D716,285;
U.S. Design Patent No. D723,560;
U.S. Design Patent No. D730,357;
U.S. Design Patent No. D730,901;
U.S. Design Patent No. D730,902;
U.S. Design Patent No. D733,112;
U.S. Design Patent No. D734,339;
International Publication No. 2013/163789;
International Publication No. 2013/173985;
International Publication No. 2014/019130;
International Publication No. 2014/110495;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2010/0265880;
U.S. Patent Application Publication No. 2011/0202554;
U.S. Patent Application Publication No. 2012/0111946;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0287258;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0342717;
U.S. Patent Application Publication No. 2014/0001267;
U.S. Patent Application Publication No. 2014/0008439;
U.S. Patent Application Publication No. 2014/0025584;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0076974;
U.S. Patent Application Publication No. 2014/0078341;
U.S. Patent Application Publication No. 2014/0078345;
U.S. Patent Application Publication No. 2014/0097249;
U.S. Patent Application Publication No. 2014/0098792;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131438;
U.S. Patent Application Publication No. 2014/0131441;
U.S. Patent Application Publication No. 2014/0131443;
U.S. Patent Application Publication No. 2014/0131444;
U.S. Patent Application Publication No. 2014/0131445;
U.S. Patent Application Publication No. 2014/0131448;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0151453;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0166755;
U.S. Patent Application Publication No. 2014/0166759;
U.S. Patent Application Publication No. 2014/0168787;
U.S. Patent Application Publication No. 2014/0175165;
U.S. Patent Application Publication No. 2014/0175172;
U.S. Patent Application Publication No. 2014/0191644;
U.S. Patent Application Publication No. 2014/0191913;
U.S. Patent Application Publication No. 2014/0197238;
U.S. Patent Application Publication No. 2014/0197239;
U.S. Patent Application Publication No. 2014/0197304;
U.S. Patent Application Publication No. 2014/0214631;
U.S. Patent Application Publication No. 2014/0217166;
U.S. Patent Application Publication No. 2014/0217180;
U.S. Patent Application Publication No. 2014/0231500;
U.S. Patent Application Publication No. 2014/0232930;
U.S. Patent Application Publication No. 2014/0247315;
U.S. Patent Application Publication No. 2014/0263493;
U.S. Patent Application Publication No. 2014/0263645;
U.S. Patent Application Publication No. 2014/0267609;
U.S. Patent Application Publication No. 2014/0270196;
U.S. Patent Application Publication No. 2014/0270229;
U.S. Patent Application Publication No. 2014/0278387;
U.S. Patent Application Publication No. 2014/0278391;
U.S. Patent Application Publication No. 2014/0282210;
U.S. Patent Application Publication No. 2014/0284384;
U.S. Patent Application Publication No. 2014/0288933;
U.S. Patent Application Publication No. 2014/0297058;
U.S. Patent Application Publication No. 2014/0299665;
U.S. Patent Application Publication No. 2014/0312121;
U.S. Patent Application Publication No. 2014/0319220;
U.S. Patent Application Publication No. 2014/0319221;
U.S. Patent Application Publication No. 2014/0326787;
U.S. Patent Application Publication No. 2014/0332590;
U.S. Patent Application Publication No. 2014/0344943;
U.S. Patent Application Publication No. 2014/0346233;
U.S. Patent Application Publication No. 2014/0351317;
U.S. Patent Application Publication No. 2014/0353373;
U.S. Patent Application Publication No. 2014/0361073;
U.S. Patent Application Publication No. 2014/0361082;
U.S. Patent Application Publication No. 2014/0362184;
U.S. Patent Application Publication No. 2014/0363015;
U.S. Patent Application Publication No. 2014/0369511;
U.S. Patent Application Publication No. 2014/0374483;
U.S. Patent Application Publication No. 2014/0374485;
U.S. Patent Application Publication No. 2015/0001301;
U.S. Patent Application Publication No. 2015/0001304;
U.S. Patent Application Publication No. 2015/0003673;
U.S. Patent Application Publication No. 2015/0009338;
U.S. Patent Application Publication No. 2015/0009610;
U.S. Patent Application Publication No. 2015/0014416;
U.S. Patent Application Publication No. 2015/0021397;
U.S. Patent Application Publication No. 2015/0028102;
U.S. Patent Application Publication No. 2015/0028103;
U.S. Patent Application Publication No. 2015/0028104;
U.S. Patent Application Publication No. 2015/0029002;
U.S. Patent Application Publication No. 2015/0032709;
U.S. Patent Application Publication No. 2015/0039309;
U.S. Patent Application Publication No. 2015/0039878;
U.S. Patent Application Publication No. 2015/0040378;
U.S. Patent Application Publication No. 2015/0048168;
U.S. Patent Application Publication No. 2015/0049347;
U.S. Patent Application Publication No. 2015/0051992;
U.S. Patent Application Publication No. 2015/0053766;
U.S. Patent Application Publication No. 2015/0053768;
U.S. Patent Application Publication No. 2015/0053769;
U.S. Patent Application Publication No. 2015/0060544;
U.S. Patent Application Publication No. 2015/0062366;
U.S. Patent Application Publication No. 2015/0063215;
U.S. Patent Application Publication No. 2015/0063676;
U.S. Patent Application Publication No. 2015/0069130;
U.S. Patent Application Publication No. 2015/0071819;
U.S. Patent Application Publication No. 2015/0083800;
U.S. Patent Application Publication No. 2015/0086114;
U.S. Patent Application Publication No. 2015/0088522;
U.S. Patent Application Publication No. 2015/0096872;
U.S. Patent Application Publication No. 2015/0099557;
U.S. Patent Application Publication No. 2015/0100196;
U.S. Patent Application Publication No. 2015/0102109;
U.S. Patent Application Publication No. 2015/0115035;
U.S. Patent Application Publication No. 2015/0127791;
U.S. Patent Application Publication No. 2015/0128116;
U.S. Patent Application Publication No. 2015/0129659;
U.S. Patent Application Publication No. 2015/0133047;
U.S. Patent Application Publication No. 2015/0134470;
U.S. Patent Application Publication No. 2015/0136851;
U.S. Patent Application Publication No. 2015/0136854;
U.S. Patent Application Publication No. 2015/0142492;
U.S. Patent Application Publication No. 2015/0144692;
U.S. Patent Application Publication No. 2015/0144698;
U.S. Patent Application Publication No. 2015/0144701;
U.S. Patent Application Publication No. 2015/0149946;
U.S. Patent Application Publication No. 2015/0161429;
U.S. Patent Application Publication No. 2015/0169925;
U.S. Patent Application Publication No. 2015/0169929;
U.S. Patent Application Publication No. 2015/0178523;
U.S. Patent Application Publication No. 2015/0178534;
U.S. Patent Application Publication No. 2015/0178535;
U.S. Patent Application Publication No. 2015/0178536;
U.S. Patent Application Publication No. 2015/0178537;
U.S. Patent Application Publication No. 2015/0181093;
U.S. Patent Application Publication No. 2015/0181109;
   U.S. patent application Ser. No. 13/367,978 for a Laser Scanning Module Employing an Elastomeric U-Hinge Based Laser Scanning Assembly, filed Feb. 7, 2012 (Feng et al.);
   U.S. patent application Ser. No. 29/458,405 for an Electronic Device, filed Jun. 19, 2013 (Fitch et al.);
   U.S. patent application Ser. No. 29/459,620 for an Electronic Device Enclosure, filed Jul. 2, 2013 (London et al.);
   U.S. patent application Ser. No. 29/468,118 for an Electronic Device Case, filed Sep. 26, 2013 (Oberpriller et al.);
   U.S. patent application Ser. No. 14/150,393 for Indicia-reader Having Unitary Construction Scanner, filed Jan. 8, 2014 (Colavito et al.);
   U.S. patent application Ser. No. 14/200,405 for Indicia Reader for Size-Limited Applications filed Mar. 7, 2014 (Feng et al.);
   U.S. patent application Ser. No. 14/231,898 for Hand-Mounted Indicia-Reading Device with Finger Motion Triggering filed Apr. 1, 2014 (Van Horn et al.);
   U.S. patent application Ser. No. 29/486,759 for an Imaging Terminal, filed Apr. 2, 2014 (Oberpriller et al.);
   U.S. patent application Ser. No. 14/257,364 for Docking System and Method Using Near Field Communication filed Apr. 21, 2014 (Showering);
   U.S. patent application Ser. No. 14/264,173 for Autofocus Lens System for Indicia Readers filed Apr. 29, 2014 (Ackley et al.);
   U.S. patent application Ser. No. 14/277,337 for MULTIPURPOSE OPTICAL READER, filed May 14, 2014 (Jovanovski et al.);
   U.S. patent application Ser. No. 14/283,282 for TERMINAL HAVING ILLUMINATION AND FOCUS CONTROL filed May 21, 2014 (Liu et al.);
   U.S. patent application Ser. No. 14/327,827 for a MOBILE-PHONE ADAPTER FOR ELECTRONIC TRANSACTIONS, filed Jul. 10, 2014 (Hejl);
   U.S. patent application Ser. No. 14/334,934 for a SYSTEM AND METHOD FOR INDICIA VERIFICATION, filed Jul. 18, 2014 (Hejl);
   U.S. patent application Ser. No. 14/339,708 for LASER SCANNING CODE SYMBOL READING SYSTEM, filed Jul. 24, 2014 (Xian et al.);
   U.S. patent application Ser. No. 14/340,627 for an AXIALLY REINFORCED FLEXIBLE SCAN ELEMENT, filed Jul. 25, 2014 (Rueblinger et al.);
   U.S. patent application Ser. No. 14/446,391 for MULTIFUNCTION POINT OF SALE APPARATUS WITH OPTICAL SIGNATURE CAPTURE filed Jul. 30, 2014 (Good et al.);
   U.S. patent application Ser. No. 14/452,697 for INTERACTIVE INDICIA READER, filed Aug. 6, 2014 (Todeschini);
   U.S. patent application Ser. No. 14/453,019 for DIMENSIONING SYSTEM WITH GUIDED ALIGNMENT, filed Aug. 6, 2014 (Li et al.);
   U.S. patent application Ser. No. 14/462,801 for MOBILE COMPUTING DEVICE WITH DATA COGNITION SOFTWARE, filed on Aug. 19, 2014 (Todeschini et al.);
   U.S. patent application Ser. No. 14/483,056 for VARIABLE DEPTH OF FIELD BARCODE SCANNER filed Sep. 10, 2014 (McCloskey et al.);
   U.S. patent application Ser. No. 14/513,808 for IDENTIFYING INVENTORY ITEMS IN A STORAGE FACILITY filed Oct. 14, 2014 (Singel et al.);
   U.S. patent application Ser. No. 14/519,195 for HANDHELD DIMENSIONING SYSTEM WITH FEEDBACK filed Oct. 21, 2014 (Laffargue et al.);
   U.S. patent application Ser. No. 14/519,179 for DIMENSIONING SYSTEM WITH MULTIPATH INTERFERENCE MITIGATION filed Oct. 21, 2014 (Thuries et al.);
   U.S. patent application Ser. No. 14/519,211 for SYSTEM AND METHOD FOR DIMENSIONING filed Oct. 21, 2014 (Ackley et al.);
   U.S. patent application Ser. No. 14/519,233 for HANDHELD DIMENSIONER WITH DATA-QUALITY INDICATION filed Oct. 21, 2014 (Laffargue et al.);
   U.S. patent application Ser. No. 14/519,249 for HANDHELD DIMENSIONING SYSTEM WITH MEASUREMENT-CONFORMANCE FEEDBACK filed Oct. 21, 2014 (Ackley et al.);
   U.S. patent application Ser. No. 14/527,191 for METHOD AND SYSTEM FOR RECOGNIZING SPEECH USING WILDCARDS IN AN EXPECTED RESPONSE filed Oct. 29, 2014 (Braho et al.);
   U.S. patent application Ser. No. 14/529,563 for ADAPTABLE INTERFACE FOR A MOBILE COMPUTING DEVICE filed Oct. 31, 2014 (Schoon et al.);
   U.S. patent application Ser. No. 14/529,857 for BARCODE READER WITH SECURITY FEATURES filed Oct. 31, 2014 (Todeschini et al.);
   U.S. patent application Ser. No. 14/398,542 for PORTABLE ELECTRONIC DEVICES HAVING A SEPARATE LOCATION TRIGGER UNIT FOR USE IN CONTROLLING AN APPLICATION UNIT filed Nov. 3, 2014 (Bian et al.);
   U.S. patent application Ser. No. 14/531,154 for DIRECTING AN INSPECTOR THROUGH AN INSPECTION filed Nov. 3, 2014 (Miller et al.);
   U.S. patent application Ser. No. 14/533,319 for BARCODE SCANNING SYSTEM USING WEARABLE DEVICE WITH EMBEDDED CAMERA filed Nov. 5, 2014 (Todeschini);
   U.S. patent application Ser. No. 14/535,764 for CONCATENATED EXPECTED RESPONSES FOR SPEECH RECOGNITION filed Nov. 7, 2014 (Braho et al.);
   U.S. patent application Ser. No. 14/568,305 for AUTO-CONTRAST VIEWFINDER FOR AN INDICIA READER filed Dec. 12, 2014 (Todeschini);
   U.S. patent application Ser. No. 14/573,022 for DYNAMIC DIAGNOSTIC INDICATOR GENERATION filed Dec. 17, 2014 (Goldsmith);
   U.S. patent application Ser. No. 14/578,627 for SAFETY SYSTEM AND METHOD filed Dec. 22, 2014 (Ackley et al.);
   U.S. patent application Ser. No. 14/580,262 for MEDIA GATE FOR THERMAL TRANSFER PRINTERS filed Dec. 23, 2014 (Bowles);
   U.S. patent application Ser. No. 14/590,024 for SHELVING AND PACKAGE LOCATING SYSTEMS FOR DELIVERY VEHICLES filed Jan. 6, 2015 (Payne);
   U.S. patent application Ser. No. 14/596,757 for SYSTEM AND METHOD FOR DETECTING BARCODE PRINTING ERRORS filed Jan. 14, 2015 (Ackley);
   U.S. patent application Ser. No. 14/416,147 for OPTICAL READING APPARATUS HAVING VARIABLE SETTINGS filed Jan. 21, 2015 (Chen et al.);
   U.S. patent application Ser. No. 14/614,706 for DEVICE FOR SUPPORTING AN ELECTRONIC TOOL ON A USER'S HAND filed Feb. 5, 2015 (Oberpriller et al.);
   U.S. patent application Ser. No. 14/614,796 for CARGO APPORTIONMENT TECHNIQUES filed Feb. 5, 2015 (Morton et al.);
   U.S. patent application Ser. No. 29/516,892 for TABLE COMPUTER filed Feb. 6, 2015 (Bidwell et al.);
   U.S. patent application Ser. No. 14/619,093 for METHODS FOR TRAINING A SPEECH RECOGNITION SYSTEM filed Feb. 11, 2015 (Pecorari);
   U.S. patent application Ser. No. 14/628,708 for DEVICE, SYSTEM, AND METHOD FOR DETERMINING THE STATUS OF CHECKOUT LANES filed Feb. 23, 2015 (Todeschini);
   U.S. patent application Ser. No. 14/630,841 for TERMINAL INCLUDING IMAGING ASSEMBLY filed Feb. 25, 2015 (Gomez et al.);
   U.S. patent application Ser. No. 14/635,346 for SYSTEM AND METHOD FOR RELIABLE STORE-AND-FORWARD DATA HANDLING BY ENCODED INFORMATION READING TERMINALS filed Mar. 2, 2015 (Sevier);
   U.S. patent application Ser. No. 29/519,017 for SCANNER filed Mar. 2, 2015 (Zhou et al.);
   U.S. patent application Ser. No. 14/405,278 for DESIGN PATTERN FOR SECURE STORE filed Mar. 9, 2015 (Zhu et al.);
   U.S. patent application Ser. No. 14/660,970 for DECODABLE INDICIA READING TERMINAL WITH COMBINED ILLUMINATION filed Mar. 18, 2015 (Kearney et al.);
   U.S. patent application Ser. No. 14/661,013 for REPROGRAMMING SYSTEM AND METHOD FOR DEVICES INCLUDING PROGRAMMING SYMBOL filed Mar. 18, 2015 (Soule et al.);
   U.S. patent application Ser. No. 14/662,922 for MULTIFUNCTION POINT OF SALE SYSTEM filed Mar. 19, 2015 (Van Horn et al.);
   U.S. patent application Ser. No. 14/663,638 for VEHICLE MOUNT COMPUTER WITH CONFIGURABLE IGNITION SWITCH BEHAVIOR filed Mar. 20, 2015 (Davis et al.);
   U.S. patent application Ser. No. 14/664,063 for METHOD AND APPLICATION FOR SCANNING A BARCODE WITH A SMART DEVICE WHILE CONTINUOUSLY RUNNING AND DISPLAYING AN APPLICATION ON THE SMART DEVICE DISPLAY filed Mar. 20, 2015 (Todeschini);
   U.S. patent application Ser. No. 14/669,280 for TRANSFORMING COMPONENTS OF A WEB PAGE TO VOICE PROMPTS filed Mar. 26, 2015 (Funyak et al.);
   U.S. patent application Ser. No. 14/674,329 for AIMER FOR BARCODE SCANNING filed Mar. 31, 2015 (Bidwell);
   U.S. patent application Ser. No. 14/676,109 for INDICIA READER filed Apr. 1, 2015 (Huck);
   U.S. patent application Ser. No. 14/676,327 for DEVICE MANAGEMENT PROXY FOR SECURE DEVICES filed Apr. 1, 2015 (Yeakley et al.);
   U.S. patent application Ser. No. 14/676,898 for NAVIGATION SYSTEM CONFIGURED TO INTEGRATE MOTION SENSING DEVICE INPUTS filed Apr. 2, 2015 (Showering);
   U.S. patent application Ser. No. 14/679,275 for DIMENSIONING SYSTEM CALIBRATION SYSTEMS AND METHODS filed Apr. 6, 2015 (Laffargue et al.);
   U.S. patent application Ser. No. 29/523,098 for HANDLE FOR A TABLET COMPUTER filed Apr. 7, 2015 (Bidwell et al.);
   U.S. patent application Ser. No. 14/682,615 for SYSTEM AND METHOD FOR POWER MANAGEMENT OF MOBILE DEVICES filed Apr. 9, 2015 (Murawski et al.);
   U.S. patent application Ser. No. 14/686,822 for MULTIPLE PLATFORM SUPPORT SYSTEM AND METHOD filed Apr. 15, 2015 (Qu et al.);
   U.S. patent application Ser. No. 14/687,289 for SYSTEM FOR COMMUNICATION VIA A PERIPHERAL HUB filed Apr. 15, 2015 (Kohtz et al.);
   U.S. patent application Ser. No. 29/524,186 for SCANNER filed Apr. 17, 2015 (Zhou et al.);
   U.S. patent application Ser. No. 14/695,364 for MEDICATION MANAGEMENT SYSTEM filed Apr. 24, 2015 (Sewell et al.);
   U.S. patent application Ser. No. 14/695,923 for SECURE UNATTENDED NETWORK AUTHENTICATION filed Apr. 24, 2015 (Kubler et al.);
   U.S. patent application Ser. No. 29/525,068 for TABLET COMPUTER WITH REMOVABLE SCANNING DEVICE filed Apr. 27, 2015 (Schulte et al.);
   U.S. patent application Ser. No. 14/699,436 for SYMBOL READING SYSTEM HAVING PREDICTIVE DIAGNOSTICS filed Apr. 29, 2015 (Nahill et al.);
   U.S. patent application Ser. No. 14/702,110 for SYSTEM AND METHOD FOR REGULATING BARCODE DATA INJECTION INTO A RUNNING APPLICATION ON A SMART DEVICE filed May 1, 2015 (Todeschini et al.);
   U.S. patent application Ser. No. 14/702,979 for TRACKING BATTERY CONDITIONS filed May 4, 2015 (Young et al.);
   U.S. patent application Ser. No. 14/704,050 for INTERMEDIATE LINEAR POSITIONING filed May 5, 2015 (Charpentier et al.);
   U.S. patent application Ser. No. 14/705,012 for HANDS-FREE HUMAN MACHINE INTERFACE RESPONSIVE TO A DRIVER OF A VEHICLE filed May 6, 2015 (Fitch et al.);
   U.S. patent application Ser. No. 14/705,407 for METHOD AND SYSTEM TO PROTECT SOFTWARE-BASED NETWORK-CONNECTED DEVICES FROM ADVANCED PERSISTENT THREAT filed May 6, 2015 (Hussey et al.);
   U.S. patent application Ser. No. 14/707,037 for SYSTEM AND METHOD FOR DISPLAY OF INFORMATION USING A VEHICLE-MOUNT COMPUTER filed May 8, 2015 (Chamberlin);
   U.S. patent application Ser. No. 14/707,123 for APPLICATION INDEPENDENT DEX/UCS INTERFACE filed May 8, 2015 (Pape);
   U.S. patent application Ser. No. 14/707,492 for METHOD AND APPARATUS FOR READING OPTICAL INDICIA USING A PLURALITY OF DATA SOURCES filed May 8, 2015 (Smith et al.);
   U.S. patent application Ser. No. 14/710,666 for PRE-PAID USAGE SYSTEM FOR ENCODED INFORMATION READING TERMINALS filed May 13, 2015 (Smith);
   U.S. patent application Ser. No. 29/526,918 for CHARGING BASE filed May 14, 2015 (Fitch et al.);
   U.S. patent application Ser. No. 14/715,672 for AUGUMENTED REALITY ENABLED HAZARD DISPLAY filed May 19, 2015 (Venkatesha et al.);
   U.S. patent application Ser. No. 14/715,916 for EVALUATING IMAGE VALUES filed May 19, 2015 (Ackley);
   U.S. patent application Ser. No. 14/722,608 for INTERACTIVE USER INTERFACE FOR CAPTURING A DOCUMENT IN AN IMAGE SIGNAL filed May 27, 2015 (Showering et al.);
   U.S. patent application Ser. No. 29/528,165 for IN-COUNTER BARCODE SCANNER filed May 27, 2015 (Oberpriller et al.);
   U.S. patent application Ser. No. 14/724,134 for ELECTRONIC DEVICE WITH WIRELESS PATH SELECTION CAPABILITY filed May 28, 2015 (Wang et al.);
   U.S. patent application Ser. No. 14/724,849 for METHOD OF PROGRAMMING THE DEFAULT CABLE INTERFACE SOFTWARE IN AN INDICIA READING DEVICE filed May 29, 2015 (Barten);
   U.S. patent application Ser. No. 14/724,908 for IMAGING APPARATUS HAVING IMAGING ASSEMBLY filed May 29, 2015 (Barber et al.);
   U.S. patent application Ser. No. 14/725,352 for APPARATUS AND METHODS FOR MONITORING ONE OR MORE PORTABLE DATA TERMINALS (Caballero et al.);
   U.S. patent application Ser. No. 29/528,590 for ELECTRONIC DEVICE filed May 29, 2015 (Fitch et al.);
   U.S. patent application Ser. No. 29/528,890 for MOBILE COMPUTER HOUSING filed Jun. 2, 2015 (Fitch et al.);
   U.S. patent application Ser. No. 14/728,397 for DEVICE MANAGEMENT USING VIRTUAL INTERFACES CROSS-REFERENCE TO RELATED APPLICATIONS filed Jun. 2, 2015 (Caballero);
   U.S. patent application Ser. No. 14/732,870 for DATA COLLECTION MODULE AND SYSTEM filed Jun. 8, 2015 (Powilleit);
   U.S. patent application Ser. No. 29/529,441 for INDICIA READING DEVICE filed Jun. 8, 2015 (Zhou et al.);
   U.S. patent application Ser. No. 14/735,717 for INDICIA-READING SYSTEMS HAVING AN INTERFACE WITH A USER′S NERVOUS SYSTEM filed Jun. 10, 2015 (Todeschini);
   U.S. patent application Ser. No. 14/738,038 for METHOD OF AND SYSTEM FOR DETECTING OBJECT WEIGHING INTERFERENCES filed Jun. 12, 2015 (Amundsen et al.);
   U.S. patent application Ser. No. 14/740,320 for TACTILE SWITCH FOR A MOBILE ELECTRONIC DEVICE filed Jun. 16, 2015 (Bandringa);
   U.S. patent application Ser. No. 14/740,373 for CALIBRATING A VOLUME DIMENSIONER filed Jun. 16, 2015 (Ackley et al.);
   U.S. patent application Ser. No. 14/742,818 for INDICIA READING SYSTEM EMPLOYING DIGITAL GAIN CONTROL filed Jun. 18, 2015 (Xian et al.);
   U.S. patent application Ser. No. 14/743,257 for WIRELESS MESH POINT PORTABLE DATA TERMINAL filed Jun. 18, 2015 (Wang et al.);
   U.S. patent application Ser. No. 29/530,600 for CYCLONE filed Jun. 18, 2015 (Vargo et al);
   U.S. patent application Ser. No. 14/744,633 for IMAGING APPARATUS COMPRISING IMAGE SENSOR ARRAY HAVING SHARED GLOBAL SHUTTER CIRCUITRY filed Jun. 19, 2015 (Wang);
   U.S. patent application Ser. No. 14/744,836 for CLOUD-BASED SYSTEM FOR READING OF DECODABLE INDICIA filed Jun. 19, 2015 (Todeschini et al.);
   U.S. patent application Ser. No. 14/745,006 for SELECTIVE OUTPUT OF DECODED MESSAGE DATA filed Jun. 19, 2015 (Todeschini et al.);
   U.S. patent application Ser. No. 14/747,197 for OPTICAL PATTERN PROJECTOR filed Jun. 23, 2015 (Thuries et al.);
   U.S. patent application Ser. No. 14/747,490 for DUAL-PROJECTOR THREE-DIMENSIONAL SCANNER filed Jun. 23, 2015 (Jovanovski et al.); and
   U.S. patent application Ser. No. 14/748,446 for CORDLESS INDICIA READER WITH A MULTIFUNCTION COIL FOR WIRELESS CHARGING AND EAS DEACTIVATION, filed Jun. 24, 2015 (Xie et al.).

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A printing device comprising:
a media feeding mechanism configured to feed print media through a print area of the printing device, the print media including a plurality of labels separated by a plurality of gaps;
a printing mechanism configured to print on the labels of the print media; and
a label stop sensing device configured to sense the gaps between the labels on the print media, the label stop sensing device further configured to provide a control signal for controlling the media feeding mechanism and printing mechanism to prevent the printing mechanism from printing outside the boundaries of the labels;
wherein the label stop sensing device performs a Fast Fourier Transform (FFT) to help predict the locations of the gaps.

2. The printing device of claim 1, wherein the gaps are configured as label stops, black marks, slots, perforations, holes, voids, or notches.

3. The printing device of claim 1, further comprising a memory device configured to store at least one table utilized by the label stop sensing device.

4. The printing device of claim 3, wherein the memory device is configured to store a first table including signal magnitude values in the time domain and a second table including reoccurring frequencies with associated magnitudes and phase values in the frequency domain.

5. The printing device of claim 4, wherein the label stop sensing device is configured to detect if sensed signal values exceed a predetermined threshold value and if the sensed signal values correlate to information in the second table.

6. The printing device of claim 1, wherein the label stop sensing device performs the FFT to filter out false gap detection for pre-printed media.

7. A label stop sensing device comprising:
a sensor configured to sense print media being fed through a printer, the print media comprising a plurality of labels separated by label stops; and
a label stop detecting module configured to receive time domain signals from the sensor, the label stop detecting module configured to perform a Fast Fourier Transform (FFT) on the time domain signals to obtain frequency domain signals, the label stop detecting module configured to detect the label stops separating the labels on the print media based on at least the frequency domain signals.

8. The label stop sensing device of claim 7, wherein the label stop detecting module is configured to use the frequency domain signals obtained by performing the FFT to predict the position of label stops for reducing missed gap detection.

9. The label stop sensing device of claim 7, wherein the label stop detecting module is configured to use the frequency domain signals obtained by performing the FFT to filter out false gap detection when pre-printed media is fed through the printer.

10. The label stop sensing device of claim 7, wherein the sensor comprises at least one photoelectric sensor.

11. The label stop sensing device of claim 7, further comprising an analog to digital converter (ADC) configured to receive analog signals from the sensor and convert the analog signals to digital signals, the ADC further configured to output the digital signals to the label stop detecting module.

12. The label stop sensing device of claim 7, further comprising a memory device configured to store tables utilized by the label stop detecting module.

13. The label stop sensing device of claim 12, wherein the memory device is configured to store a time domain table that includes magnitude values in the time domain.

14. The label stop sensing device of claim 12, wherein the memory device is configured to store a frequency domain table that includes reoccurring frequencies with associated magnitude values and phase values in the frequency domain.

15. The label stop sensing device of claim 14, wherein the label stop detecting module is configured to detect if signal magnitude values exceed a predetermined threshold value and if signal magnitude values correlate to information in the frequency domain table.

16. A method associated with a printer, the method comprising the steps of:
sensing print media being fed through a printer, the print media comprising a plurality of labels separated by gaps;
performing a Fast Fourier Transform (FFT) on the sensed print media; and
detecting the gaps between the labels on the print media based on at least frequency domain signals.

17. The method of claim 16, further comprising the steps of:
controlling a media feeding mechanism to feed the print media through a print area of the printer; and controlling a printing mechanism to print inside the boundaries of the labels of the print media.

18. The method of claim 16, further comprising the step of performing the FFT to help predict the locations of the gaps and to filter out false gap detection when pre-printed media is fed through the printer.

19. The method of claim 16, further comprising the step of accessing a first table that includes magnitude values in the time domain and accessing a second table that includes reoccurring frequencies with associated magnitude values and phase values in the frequency domain.

20. The method of claim 19, wherein the step of detecting the gaps includes detecting if signal magnitude values exceed a predetermined threshold value and if the signal magnitude values correlate to information in the second table.
